(19) United States
(12) Patent Application Publication
(10) Pub. No.: US 2013/0026106 A1
(43) Pub. Date: Jan. 31, 2013

(54) OPTIMIZED FLOCCULATION OF ALGAE USING CATIONIC POLYMERS

(71) Applicant: Matthew Liberatore, Arvada, CO (US)

(72) Inventor: Matthew Liberatore, Arvada, CO (US)

(21) Appl. No.: 13/547,991

(22) Filed: Jul. 12, 2012

Related U.S. Application Data
(60) Provisional application No. 61/512,691, filed on Jul. 28, 2011.

(51) Int. Cl. B01D 21/01

(52) U.S. Cl. 210/732

(57) ABSTRACT

A concentration of cationic polymer is able to floc algae cells in about 30 minutes compared to the 30+ hours for the cells to flocculate and settle without additives. The addition of the polymer requires less than 1 wt % polymer to complete the algae floc and does not require large amounts of energy to perform or extra processing steps to recover the flocculent.

### CROSS REFERENCE TO RELATED APPLICATIONS

This non-provisional patent application claims the benefit of priority from U.S. Provisional Patent Application No. 61/512,691 filed on Jul. 28, 2011, the disclosure of which is hereby incorporated by reference in its entirety.

### FIELD OF THE INVENTION

The present invention relates to the separation of algae from a growing medium. More specifically, the invention relates to a method to floc algae using a polymer at an optimal concentration.

### BACKGROUND

Algae can be grown naturally or in bioreactors. However, the growing process requires the use of a growing medium. Algae are typically suspended in approximately 99 weight percent of the growing medium, which is typically water and nutrients. This growing medium must be separated from the algae before it can be processed for several applications.

On small scales, the growing medium can be separated from algae using processes such as centrifuging. However, flocculation and dewatering of algae cells is one of the largest challenges in creating large scale applications from algae. Algae, which are denser than the growing medium, will eventually settle to the bottom of a container if left undisturbed. However, the time period required to settle is approximately 30-70 hours, which is unfeasible for large scale operations. Harvesting algae with chemical flocculation (e.g., alum) is typically too expensive for large scale operations due to waste water processing. Many processes like centrifugation and filtration are also not practical on a large scale due to the necessity of dewatering the cells. Thus, there is a need for a large scale, inexpensive manner to floc algae.

### SUMMARY

Once algae are separated from the fluid medium, it can be used for several different applications. For example, algae can be used for food, vitamin supplements, dyes, or fertilizers. Algae oils can also be extracted for biofuels.

The present invention utilizes a cationic polymer to decrease the settling time of the algae. The cationic polymer may be added as a solid or may be diluted in water prior to adding the polymer to the algae and growth medium. The polymer attaches to the algae and decreases the time for the algae to settle. Furthermore, cationic polymers are relatively inexpensive and readily available in large scale.

In one embodiment of the present invention a method to floc algae is provided, and comprising adding a cationic polymer to a growth medium with algae, wherein the cationic polymer added to the growth medium is between about 0.05 and about 1 wt %.

### DETAILED DESCRIPTION

Algae, which can be grown on large scales, can be used for several applications once the algae are removed from the growing medium.

The present invention relates to the separation of algae from a growing medium. More specifically, the invention relates to a method to decrease the time to floc algae using a polymer at an optimal concentration.

Floc as used herein refers to a clumped or aggregated mass or lump of particles. Flocculation as used herein is defined as a process to make floc, in other words, causing the particles to form a mass or lump.

One aspect of this invention utilizes a polymer in order to promote settling and drastically decrease the time required for the algae to settle. Cationic, water soluble polymers may be used with this invention. These polymers include UCARE™ Polymers available from Dow©, in particular UCARE™ Polymer LR 400, UCARE™ Polymer JR 400, UCARE™ Polymer LR 30M, and UCARE Polymer JR 30M. These polymers may be deposited directly into the algae and growth medium or they may be mixed with water, then added to the algae and growth medium. No preprocessing of the algae medium is necessary with this process and it may be used over a range of pH.

The amount of polymer added to the algae and growing medium is important. If too little of the polymer is added, the time to settle the algae will be long, but still less than if no polymer was added. If there is too much of the polymer added, then the time to settle will be long, but still less than if no polymer was added. The optimal amount of polymer added to the algae and growing medium is approximately 0.05-1 wt %, in some embodiments between about 0.05-0.4 wt/% and preferably about 0.15 wt %.

After the polymer is added, the algae cells interact with the polymer and quickly settle. The average time to settle the algae is between about 30 minutes to about 15 hours (versus 30-70 hours without polymer). After the algae has settled to the bottom, the growing medium may be separated using known methods, such as decanting. The polymer will remain with the cellular matter (e.g., cell walls, intercellular components) after the primary product, likely oil or starch, is separated. The polymer and cellular matter will be burned for heat and power or further refined via pyrolysis or other techniques.

### EXAMPLES

### Example 1

Polymer UCARE™ Polymer LR 400 was tested to determine the flocculation time with the algae and growth medium as a function of the amount of polymer added to the algae and growth medium. The polymer was diluted to 1 wt % in water. Different amounts of the polymer were subsequently added to 5 mL of the algae and growth medium. The results are shown in Table 1.

TABLE 1
The effect on flocculation time as a function of the amount of polymer.

| Sample | LR400_{Stock (g)} | Weight % Stock | Time to Flock (hrs) |
|---|---|---|---|
| 1 | 0.01 | 0.050 | 7.00 |
| 2 | 0.01 | 0.050 | 6.50 |
| 3 | 0.01 | 0.050 | 6.00 |
| 4 | 0.015 | 0.075 | 6.50 |
| 5 | 0.015 | 0.075 | 6.00 |
| 6 | 0.02 | 0.100 | 1.13 |
| 7 | 0.02 | 0.100 | 0.83 |
| 8 | 0.02 | 0.100 | 0.92 |
| 9 | 0.035 | 0.175 | 0.67 |
| 10 | 0.035 | 0.175 | 0.58 |
| 11 | 0.05 | 0.249 | 3.50 |
| 12 | 0.05 | 0.249 | 2.17 |
| 13 | 0.05 | 0.249 | 1.92 |
| 14 | 0.05 | 0.249 | 1.50 |
| 15 | 0.07 | 0.349 | 2.83 |
| 16 | 0.1 | 0.498 | 6.00 |
| 17 | 0.1 | 0.498 | 5.50 |
| 18 | 0.1 | 0.498 | 4.00 |
| 19 | 0.1 | 0.498 | 3.75 |
| 20 | 0.12 | 0.596 | 5.58 |
| 21 | 0.12 | 0.596 | 5.25 |
| 22 | 0.15 | 0.744 | 7.50 |
| 23 | 0.15 | 0.744 | 7.00 |
| 24 | 0.15 | 0.744 | 6.00 |
| 25 | 0.2 | 0.990 | 7.00 |
| 26 | 0.2 | 0.990 | 8.00 |
| 27 | 0.3 | 1.478 | 7.50 |
| 28 | 0.4 | 1.961 | 12.00 |
| 29 | 0.035 | 0.175 | 0.83 |
| 30 | 0.035 | 0.175 | 0.83 |

### Example 2

UCARE™ Polymer LR 400 was tested to determine the flocculation time with the algae and growth medium as a function of polymer dilution and the amount of polymer added to the algae and growth medium.

TABLE 2
The effect of flocculation time as a function of polymer dilution.

| | | | V_{LR400} | | | | Time |
|---|---|---|---|---|---|---|---|
| | | Dilution | ₛₒₗₙ | V_{stock} | | Weight | to |
| Sam- | V_{LR400} | (DI) | ₜₒₜₐₗ | ₛₒₗₙ | LR400_{Stock} | % | Flock |
| ple | (μL) | (μL) | _{(μL)} | _{(μL)} | _{(g)} | Stock | (hrs) |
| 1 | 175 | 825 | 1000 | 200 | 2 | 0.173 | 0.83 |
| 2 | 175 | 825 | 1000 | 200 | 2 | 0.173 | 0.83 |
| 3 | 175 | 0 | 175 | 200 | 2 | 0.990 | 1.92 |
| 4 | 175 | 0 | 175 | 200 | 2 | 0.990 | 1.92 |
| 5 | 125 | 875 | 1000 | 200 | 2 | 0.124 | 0.92 |
| 6 | 140 | 860 | 1000 | 200 | 2 | 0.139 | 0.57 |
| 7 | 150 | 850 | 1000 | 200 | 2 | 0.149 | 0.62 |
| 8 | 160 | 840 | 1000 | 200 | 2 | 0.158 | 0.62 |
| 9 | 175 | 825 | 1000 | 200 | 2 | 0.173 | 0.62 |
| 10 | 190 | 810 | 1000 | 200 | 2 | 0.188 | 0.75 |
| 11 | 200 | 800 | 1000 | 200 | 2 | 0.198 | 1.17 |
| 12 | 125 | 875 | 1000 | 200 | 2 | 0.124 | 1.25 |
| 13 | 135 | 865 | 1000 | 200 | 2 | 0.134 | 1.25 |
| 14 | 145 | 855 | 1000 | 200 | 2 | 0.144 | 0.83 |
| 15 | 155 | 845 | 1000 | 200 | 2 | 0.153 | 0.83 |
| 16 | 165 | 835 | 1000 | 200 | 2 | 0.163 | 0.83 |
| 17 | 175 | 825 | 1000 | 200 | 2 | 0.173 | 1.08 |
| 18 | 185 | 815 | 1000 | 200 | 2 | 0.183 | 0.92 |
| 19 | 50 | 950 | 1000 | 200 | 2 | 0.050 | 15.00 |
| 20 | 100 | 900 | 1000 | 200 | 2 | 0.099 | 10.00 |
| 21 | 110 | 890 | 1000 | 200 | 2 | 0.109 | 1.00 |
| 22 | 125 | 875 | 1000 | 200 | 2 | 0.124 | 1.25 |
| 23 | 140 | 860 | 1000 | 200 | 2 | 0.139 | 0.92 |
| 24 | 150 | 850 | 1000 | 200 | 2 | 0.149 | 0.92 |
| 25 | 165 | 835 | 1000 | 200 | 2 | 0.163 | 0.92 |

### Example 3

Samples of the UCARE™ Polymer LR 400 were tested to determine the time to settle as a function of the volume of the polymer added to floc the algae. The volume of the algae was constant for each sample and was 5 mL. The results are shown in Table 3.

TABLE 3
The effect on the time to settle as a function of the volume of polymer.

| | | Time to settle |
|---|---|---|
| Sample | Volume of polymer (μl) | (hr) |
| 1 | 100 | 1.5 |
| 2 | 200 | 2.5 |
| 3 | 300 | 6 |
| 4 | 400 | 7.5 |
| 5 | 500 | 12 |
| 6 | 600 | 10 |
| 7 | 700 | 10 |
| 8 | 800 | 10 |
| 9 | 900 | 10 |
| 10 | 0 | 18 |

### Example 4

Polymer UCARE™ Polymer LR 30M was tested to determine the flocculation time with the algae and growth medium as a function of the amount of polymer added to the growth medium and the effect of dilution. The UCARE™ polymer LR 30M in each sample was 0.2 g. The results are shown in Table 4.

TABLE 4
The effect on the flocculation time as
a function of the amount of polymer.

| | | Dilution | V_{LR30M} | | | Time to |
|---|---|---|---|---|---|---|
| | V_{LR30M} | (DI) | _{soln total} | V_{stock} | Weight % | Flock |
| Sample | (μL) | (μL) | _{(μL)} | _{soln (g)} | Stock | (hr) |
| 1 | 125 | 875 | 1000 | 20.012 | 0.12 | 0.58 |
| 2 | 135 | 865 | 1000 | 20.012 | 0.13 | 0.67 |
| 3 | 145 | 855 | 1000 | 20.012 | 0.14 | 0.92 |
| 4 | 155 | 845 | 1000 | 20.012 | 0.15 | 1.08 |
| 5 | 165 | 835 | 1000 | 20.012 | 0.16 | 1.08 |
| 6 | 175 | 825 | 1000 | 20.012 | 0.17 | 1.17 |
| 7 | 185 | 815 | 1000 | 20.012 | 0.18 | 0.50 |
| 8 | 195 | 805 | 1000 | 20.012 | 0.19 | 2.50 |
| 9 | 205 | 795 | 1000 | 20.012 | 0.20 | 3.50 |
| 10 | 215 | 785 | 1000 | 20.012 | 0.21 | 5.83 |
| 11 | 225 | 775 | 1000 | 20.012 | 0.22 | 4.50 |
| 12 | 235 | 765 | 1000 | 20.012 | 0.23 | 4.50 |
| 13 | 245 | 755 | 1000 | 20.012 | 0.24 | 2.00 |
| 14 | 255 | 745 | 1000 | 20.012 | 0.25 | 1.92 |
| 15 | 115 | 885 | 1000 | 20.012 | 0.11 | 0.75 |
| 16 | 105 | 895 | 1000 | 20.012 | 0.10 | 0.83 |
| 17 | 95 | 905 | 1000 | 20.012 | 0.09 | 1.00 |
| 18 | 85 | 915 | 1000 | 20.012 | 0.08 | 1.42 |
| 19 | 265 | 735 | 1000 | 20.012 | 0.26 | 0.92 |
| 20 | 275 | 725 | 1000 | 20.012 | 0.27 | 2.50 |
| 21 | 285 | 715 | 1000 | 20.012 | 0.28 | 4.00 |
| 22 | 295 | 705 | 1000 | 20.012 | 0.29 | 6.50 |
| 23 | 125 | 875 | 1000 | 20.012 | 0.12 | 0.83 |
| 24 | 135 | 865 | 1000 | 20.012 | 0.13 | 1.42 |
| 25 | 145 | 855 | 1000 | 20.012 | 0.14 | 1.08 |
| 26 | 155 | 845 | 1000 | 20.012 | 0.15 | 1.17 |
| 27 | 165 | 835 | 1000 | 20.012 | 0.16 | 2.50 |
| 28 | 305 | 695 | 1000 | 20.012 | 0.30 | 3.25 |
| 29 | 315 | 685 | 1000 | 20.012 | 0.31 | 12.00 |
| 30 | 325 | 675 | 1000 | 20.012 | 0.32 | 14.50 |
| 31 | 345 | 655 | 1000 | 20.012 | 0.34 | 13.50 |
| 32 | 365 | 635 | 1000 | 20.012 | 0.36 | 19.00 |
| 33 | 385 | 615 | 1000 | 20.012 | 0.38 | 19.50 |
| 34 | 400 | 600 | 1000 | 20.012 | 0.40 | 27.00 |
| 35 | 420 | 580 | 1000 | 20.012 | 0.42 | 27.00 |
| 36 | 450 | 550 | 1000 | 20.012 | 0.45 | 30.00 |
| 37 | 100 | 900 | 1000 | 20.012 | 0.10 | 0.58 |
| 38 | 110 | 890 | 1000 | 20.012 | 0.11 | 1.00 |
| 39 | 115 | 885 | 1000 | 20.012 | 0.11 | 0.83 |
| 40 | 175 | 825 | 1000 | 20.012 | 0.17 | 1.75 |
| 41 | 185 | 815 | 1000 | 20.012 | 0.18 | 2.25 |
| 42 | 195 | 805 | 1000 | 20.012 | 0.19 | 2.58 |
| 43 | 205 | 795 | 1000 | 20.012 | 0.20 | 2.50 |
| 44 | 215 | 785 | 1000 | 20.012 | 0.21 | 3.50 |
| 45 | 225 | 775 | 1000 | 20.012 | 0.22 | 6.50 |

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims. Further, the invention(s) described herein are capable of other embodiments and of being practiced or of being carried out in various ways. In addition, it is to be understood that the phraseology and terminology used herein is for the purposes of description and should not be regarded as limiting. The use of “including,” “comprising,” or “adding” and variations thereof herein are meant to encompass the items listed thereafter and equivalents thereof, as well as, additional items.

1. A method to floc algae, comprising:
adding a cationic polymer to a growth medium with algae, wherein the cationic polymer added to the growth medium is between about 0.05 and about 1 wt %.

2. The method of claim 1, wherein the cationic polymer is UCARE™ LR 400.

3. The method of claim 1, wherein the cationic polymer is UCARE™ LR 30M.

4. The method of claim 1, wherein the cationic polymer added to the growth medium is about 0.15 wt %.

5. The method of claim 1, wherein the cationic polymer is UCARE™ Polymer JR 400.

6. The method of claim 1, wherein the cationic polymer is UCARE Polymer JR 30M.

7. The method of claim 1, wherein the cationic polymer is deposited directly into the growth medium.

8. The method of claim 1, wherein the cationic polymer is mixed with water then added to the growth medium.

9. The method of claim 1, wherein a time to settle the floc algae is between about 30 minutes to about 15 hours.

10. The method of claim 1, wherein the cationic polymer added to the growth medium is between about 0.05-0.4 wt %.

11. The method of claim 1, wherein after the floc algae has settled, fluid is removed from the growth medium with the cationic polymer.

12. The method of claim 11, wherein the fluid is removed by decanting.
